(19) United States
(12) Patent Application Publication
(10) Pub. No.: US 2004/0082321 A1
(43) Pub. Date: Apr. 29, 2004

(54) Method for addressing communication and a communication service center

(76) Inventor: Ari Kontianinen, Tampere (FI)

Correspondence Address: Crawford Maunu, Suite 390, 1270 Northland Drive, Mendota Heights, MN, 55120, US

(21) Appl. No.: 10/469,223

(22) PCT Filed: Mar. 1, 2002
(86) PCT No.: PCT/FI02/00160

(51) Int. Cl. H04M 3/42; H04Q 7/20

(52) U.S. Cl. 455/415; 455/456.1; 455/433

(57) ABSTRACT

The invention relates to a method for addressing communication from an originator subscriber (UE1) to a recipient subscriber (UE2) having a subscriber identifier enabling a routing of the communication via a communications network (GSM) by the steps of sending to a communication service entity communication provided with specific information, which is associated with the desired recipient of the communication but is other than said subscriber identifier of the recipient, as an alternative destination address of the communication, converting at said communication service entity said alternative address into said subscriber identifier of the desired recipient (UE2), and sending said communication from said communication service entity to said desired recipient (UE2) on the basis of said converted subscriber identifier.

### FIELD OF THE INVENTION

The present invention relates to a method for addressing a communication between at least two users via a communications network.

### BACKGROUND OF THE INVENTION

Mobile communications system generally refers to any telecommunications system wherein an access point (typically wireless access) to the system can change when users are moving within the service area of the system. In mobile communications systems, as in all telephone systems, each mobile subscriber or mobile unit is assigned a unique subscriber identifier or address, such as a telephone number or IP address. The communication in these communications systems rely on the use of such identifier, so that when a call or a message is destined to such subscriber identifier, the call or message will be automatically routed to the respective mobile subscriber or mobile unit.

### BRIEF DISCLOSURE OF THE INVENTION

An object of the present invention is to provide a method and mechanism for enabling communication to a party whose subscriber identifier is unknown.

This object and other advantages provided by the invention are achieved by a method as claimed in claim 1 and a communication service center as claimed in claim 8. Preferred embodiments of the invention are disclosed in the dependent claims.

The present invention is based on the use of specific information, which is associated with the desired recipient of the call but other than a subscriber identifier (such as telephone number) of the recipient, as an alternative destination address of the communication. The communication with the alternative address is routed to a network entity, which translates the alternative address into the subscriber identifier of the desired recipient so that the communication can be forwarded to the destination.

In the preferred embodiment of the invention the alternative address is the registration number of a vehicle. For example, sometimes on a parking area there can be an empty car with lights on. Presently, if the parking lot is in a shopping mall, for instance, it is easy for a person who has recognised the situation to go to the information and inform a clerk. The clerk can then announce the situation via a public address system hoping that the owner of the car catches the announcement. On the other hand, if there is no such public address system or if the car with lights on is in the countryside it is almost impossible to reach the owner of the car and tell her/him that the lights are on. The identity or the telephone number of the owner is normally unknown. An advantage of the invention is that now a person who does not know the mobile station number or the address of a vehicle owner is able to initiate communication with her/him using the registration number as an alternative addressing which is associated with the owner.

There are numerous identical situations, where an outsider wants to contact another person without knowing her/him or without being able to contact her/him face to face, but in which situations the outsider is able to see and/or find some kind of information apparently associated with the other person.

In a further embodiment of the invention, location of the originator and recipient of the communication is determined, and the communication is carried out only in the case where the originator and the recipient are located within substantially the same area.

### BRIEF DESCRIPTION OF THE DRAWINGS

In the following the invention will be described in greater detail by means of preferred embodiments with reference to the attached drawings, in which

FIG. 1 is a general view of a communications system to which the invention can be applied; and

FIG. 2 illustrates a signalling graph of the invention and its embodiments.

### DETAILED DESCRIPTION OF THE INVENTION

The address of a mobile station outside of a mobile communications network is called a mobile station ISDN (MISDN). It has the same format as the ISDN address which is based on ITU-T Recommendation E.164. Unlike a conventional telephone call, a call to a mobile station does not identify the called party but a home exchange, network and/or subscriber database, such as home location register HLR. The HLR uses this number to provide routing instructions to other components in order to reach the subscriber. Within the mobile communications system each mobile unit is identified uniquely with a set of values. These values are used to identify the country in which the mobile system resides, the mobile network, and the mobile subscriber (MSIC, Mobile Subscriber Identification Code). These sets of values stored in a subscriber identification module (SIM) are known as the international mobile subscriber identification (IMSI) and are used as a fixed identifier within a network. The IMSI is also called the IMSN, for the international mobile subscriber number. The format for the IMSI may comprise up to 15 digits.

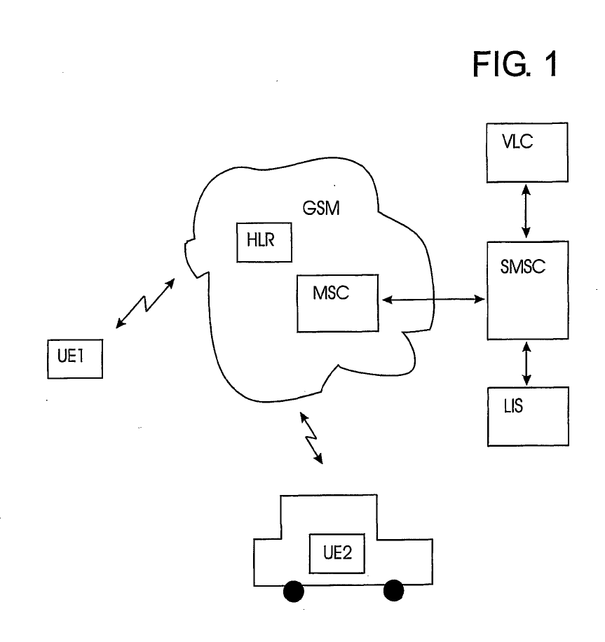

FIG. 1 illustrates a general system chart of a communications system to which the invention can be applied. The system chart in its simplest form firstly consists of two user equipment UE1 and UE2. One or both of the equipment can be located in a vehicle, for instance in a car. The user equipment UE1 and UE2 may be conventional mobile stations equipped with a short message service. Although in the following the invention will be described by means of a common phone call and/or a short message and a short message service, an interaction may comprise in addition to the common phone call e.g. at least one of the following messages: a short message, an instant message, an e-mail message, a video message, a multimedia message, a unified messaging message, a WAP (Wireless Application Protocol) message or a SIP (Session Initiation Protocol) message. The user equipment may also be the user equipment equipped with e.g. an instant message, an e-mail message, a video message, a multimedia message, a unified messaging message, a WAP (Wireless Application Protocol) message service, or a SIP (Session Initiation Protocol) message service.

Both of the user equipment UE1 and UE2 are connected to a communication network, for instance to a digital mobile system, i.e. the GSM (Global System for Mobile Communications) system GSM. The MSC (Mobile Services Switching Center) of the GSM network has a signalling connection to HLR (Home Location Register). A short message service center SMSC has a communication connection to the MSC. The SMSC has communication connections to LIS (Location Information System) and VLC (Vehicle Licence Center). In accordance with the basic principles of the invention, an alternative address that is other than a mobile subscriber identification code (MSIC) is used for starting communication from the user of a first user equipment (UE1) to the user of a second equipment (UE2), e.g. to combine a vehicle registration number with a mobile station owner information and a mobile station location information for starting communication to a recipient.

To this aim, the VLC maintains a register of the vehicle owners. The VLC may include e.g. the following data: the registration number of the vehicle, and name, address and personal identification code of the owner. From the viewpoint of the invention, it is only relevant that the VLC, in response to an inquiry containing a registration number of a vehicle, is able to respond with any kind of information which can be used for unambiguous identification of the owner so that his telephone number can be found.

The LIS is any system which determines the location or position of the mobile subscribers, and sends the location information to a requesting entity. There are various user positioning methods and systems available for mobile communications networks. Most positioning methods are based on triangulation and measurements made by the base stations. An example of positioning systems is disclosed in LCS standards, like GSM 03.71 version 8.0.0 Release 1999.Alternatively, location data indicating the current cell or the current location area of the mobile station may be sufficient for the purposes of the present invention. Such information (a cell ID or a location area ID) is already available in the databases of the mobile communications network, such as in the visitor location register VLR. Thus, the LIS may also be such database of the mobile communications network.

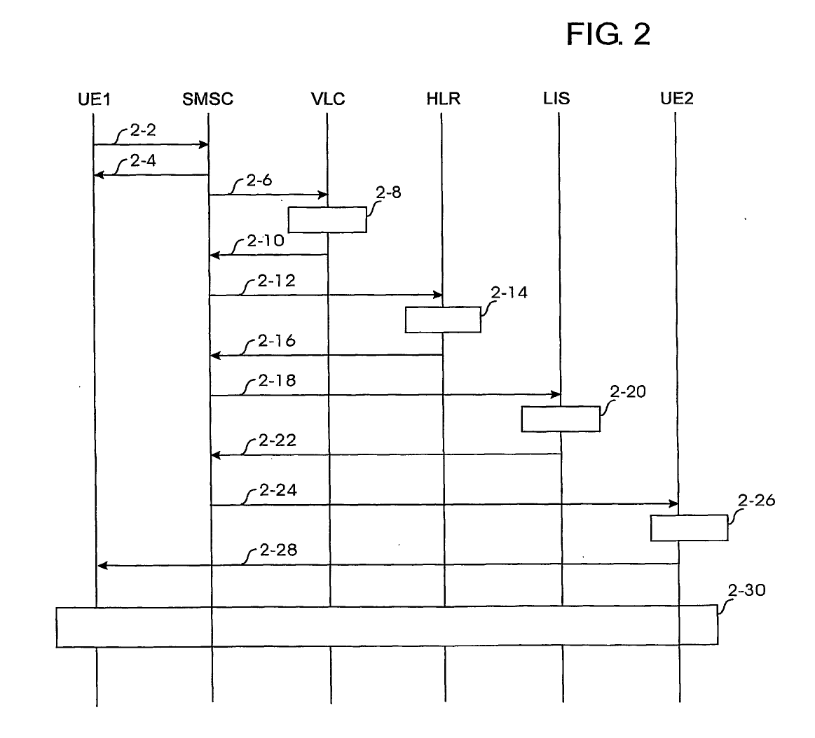

FIG. 2 illustrates a signalling diagram of the invention and its embodiments. In step 2-2 the user of UE1 sends a message, e.g. a short message destined to the user of UE2. In the digital mobile system GSM, the short message is communicated via the GSM network to the SMSC of the user of UE1. In a conventional case, the short message would contain the MSISDN of UE2, and the SMSC would forward the short message on the basis of this MSISDN number. Let us now assume that because the MSISDN of UE2 is not known, an alternative addressing method must be used instead of the phone number. The alternative address that can be the register number of a vehicle, for instance, can then be written by the user of UE1 at the beginning of the text portion a short message. Similarly, the alternative address can be written onto a form of a WAP server offering WAP services, onto a form of a WWW server offering Internet services etc.

The alternative address may be typed as a normal string. The form of the alternative address may be as follows:

<service><register number>[area, acknowledgement]<message>

in which

service: a string informing a message center that a registration number is sent instead of a phone number;

register number: the register number of a recipient;

area: area/narea: area checking/no area checking;

acknowledgement: ack/nac: an acknowledgement is wanted or not;

message: what is to be said and sent.

A message like “reg JB-007 ack Lights on in your car” would inform the message center and the recipient that to the owner of a car, whose register number is JB-007 is to be sent a message that s/he has lights on in her/his car. In the preferred embodiment, the short message is first sent to a specific message center or service which can utilize this information. Therefore, the user will dial the number of such message center as the recipient number of the message. The number may be 400, for example. The message center may be the same or similar message center which also provides other messaging services, such as news services, to mobile users. The new service according to the invention is distinguished from other services on the basis of the service string discussed above.

Also the sender of the short message would be informed whether the delivery of the message was successful or not. This may happen once or more often in different phases of the procedure, like in the phases 24, 2-10, 2-16, 2-22, 2-28 if the user of UE1 is willing to get a response on the status of the message delivery or possibly some other form of communication initiation success. The response may also be optional so that the user of UE1 may not be interested in it and that the feature is not used.

Let us now assume that the short message is sent to the SMSC shown in FIG. 1. Upon receiving the short message, SMSC interprets the alternative address and starts a procedure for converting the register number into an appropriate MSISDN number of the recipient. To this end, the SMS sends an inquiry containing the register number to the VLC in step 2-6.

In step 2-8 VLC receives the message inquiring the owner of a vehicle and carries out some procedures in order to find out an identifier of the owner of the vehicle, or of a registered user of the vehicle, on the basis of the register number. The identifier can be the identification number of the owner, for instance. In step 2-10 VLC returns that identification to the SMSC.

Having now the name of the owner of the vehicle, the SMSC sends another message containing the identification of the owner to the HLR in step 2-12. In the message the SMSC asks HLR to retrieve the MSISDN of the owner of the vehicle. Based at least partly on the identification of the owner of the vehicle, the HLR seeks in step 2-14 for the MSISDN of the user and returns it in the response 2-16 to the SMSC. It should be noted that, instead of the HLR, the MSISDN can be retrieved from any database or register which maintains the required mapping between the identification of the owner and the MSISDN number.

The SMSC handles the answer and may optionally ask, in step 2-18, the location information of the users UE1 and UE2 from the LIS. The user of UE1 or UE2 may have prohibited the positioning of himself and the delivering of the location information, i.e. disabled optionally a location checking, which disabling information can also be stored in the VLC or in the HLR. The location inquiry to the LIS is optional in a sense that the user of the UE1 is able to activate the location checking by inserting the area parameter in the alternative address string in the short message, as discussed above. If the area parameter is not present, no location checking is made. The user of UE1 may want to restrict the message delivery to the immediate neighbourhood for various reasons. For example, the location information may be needed for the fact that if the owner is not in or near the vehicle having the lights on, there may be no use to send the message to him, because he cannot turn the lights off anyway.

In step 2-20 the LIS receives the message inquiring the location information of the UE1 and UE2 and produces that location information. In step 2-22 the LIS returns the location information to the SMSC as an appropriate message, for instance in form of the geographical coordinates of the UE1 and UE2.

If the UE1 and UE2 are located within a predetermined distance apart from each other, the short message is sent from the SMSC to the UE2 on the basis of the MSISDN obtained from the HLR. In step 2-26 the short message is shown on the display of UE2. The user of UE2 may send an answer message in step 2-28. It is further possible that the UE1 and UE2 will establish a speech connection or other communication connection there between in the step 2-30. Such establishment of the further communication may be carried out even automatically by the SMSC or other entity which is responsible for the address conversion and message delivery.

If someone other than the owner of a vehicle is on the road, the message does not of course directly reach the driver of that vehicle. In those cases if no area checking is off, the message may be delivered to the owner of the car no matter how far away s/he is from her/his car. After s/he has obtained the message s/he can phone to the driver of the car in case she knows who is driving her car. If the area checking is on and the owner of a car is not in or near the car, the message will not be delivered and that situation can also be informed to the sender of the short message.

The inventive idea and its field of application can further be described by the following examples.

Case 1: When driving on a motorway, a male person wants to communicate with a female person driving in a vehicle in front of him. He does not know the mobile station number or the address of the vehicle owner, but he still wants to initiate communication with her. To do that he needs to use alternative addressing. He then forms a message and sends it to the recipient using the register number of her vehicle as an address. If the owner of the vehicle owns a mobile station and if it is located in the same area, a message is delivered to her.

Case 2: Lights are on in a car in a car park. A person wants to inform the user of the car about it and initiates a call using the license plate number of the car as an address.

Case 3: A sail is not in sailing trim in a sailing boat. A person in a nearby motorboat detects the situation and wants to inform the captain of the sailing boat about it. He then initiates a call using the register number of the boat or the name of the boat as an address.

It appears from these examples that the inventive idea is on the area of mobile services offered not only to wide audience but also to users of private networks, i.e. to users with mobile phones or other type of user equipment.

It will be obvious to a person skilled in the art that, as the technology advances, the inventive concept can be implemented in various ways. The invention and its embodiments are not limited to the examples described above but may vary within the scope of the claims.

1. A method for addressing communication from an originating subscriber (UE1) to a recipient subscriber (UE2) having a subscriber identifier enabling routing of the communication via a communications network (GSM), characterized by
sending to a communication service entity a communication provided with specific information, which is associated with the desired recipient of the communication but is other than said subscriber identifier of the recipient, as an alternative destination address of the communication,
converting at said communication service entity said alternative address into said subscriber identifier of the desired recipient (UE2),
sending said communication from said communication service entity to said desired recipient (UE2) on the basis of said converted subscriber identifier.

2. A method according to claim 1, characterized in that said step of converting comprises further steps of
inquiring identification data of the recipient on the basis of said specific information from a first information entity (VLC) which has a database mapping said specific information to said identification data,
using said identification data of the recipient for inquiring said subscriber identifier of the recipient from an information entity (HLR) which has a database mapping said identification data to said subscriber identifier.

3. A method according to claim 2, characterized in that said specific information is a registration number of a vehicle, and that said first information entity (VLC) has a database mapping said registration number to the identification data of owner or the user of said vehicle.

4. A method according to claim 1, 2 or 3, characterized by determining location of said originating subscriber and said recipient, sending said communication to said recipient (UE2) only if the recipient (UE2) and the originator (UE1) are located within the same area or within a predetermined distance from each other.

5. A method according to claim 4, characterized in that said step of determining comprises a further step of inquiring said location of said recipient (UE2) and said originator (UE1) from a subscriber positioning system (LIS).

6. A method according to any one of the preceding claims, characterized in that said communication is a message.

7. A method according to claim 6, characterized in that said specific information is inserted as a part of a character string in an information field of said message which is first addressed to said communication service entity, said character field containing also a code which indicates a type of the specific information and the service requested, and that the communication service entity makes said conversion into said subscriber identifier of said recipient on the basis of said string.

8. A communication service center for forwarding communication from an originating subscriber (UE1) to a recipient subscriber (UE2) having a subscriber indentifier enabling routing of the communication via a communications network (GSM), characterized in that
said service center is arranged to receive, from said originator, a communication provided with specific information, which is associated with the desired recipient of the communication but is other than said subscriber identifier of the recipient, as an alternative destination address of the communication,
said service center is arranged to convert said alternative address into said subscriber identifier of the desired recipient (UE2),
said service center is arranged to send said communication from said communication service entity to said desired recipient (UE2) on the basis of said converted subscriber identifier.

9. A service center according to claim 8, characterized in that
said service center is arranged to inquire identification data of the recipient on the basis of said specific information from a first information entity (VLC) which has a database mapping said specific information to said identification data,
said service center is arranged to use said identification data of the recipient for inquiring said subscriber identifier of the recipient from an information entity (HLR) which has a database mapping said identification data to said subscriber identifier.

10. A service center according to claim 9, characterized in that said specific information is a registration number of a vehicle, and that said first information entity (VLC) has a database mapping said registration number to identification data of owner or user of said vehicle.

11. A service center according to claim 8, 9 or 10, characterized in that
said service center is arranged to determine location of said originating subscriber and said recipient,
said service center is arranged to send said communication to said recipient only if the recipient and the originator are located within the same area or within a predetermined distance from each other.

12. A service center according to claim 11, characterized in that said service center is arranged to inquire said location of said recipient and said originator from a subscriber positioning system (LIS).

13. A service center according to any one of claims 8 to 12, characterized in that said communication is a message.

14. A service center according to claim 13, characterized in that said specific information is inserted as a part of a character string in a information field of said message which is first addressed to said communication service entity, said character field containing also a code which indicates a type of the specific information and the service requested, and that said service center is arranged to make said conversion into said subscriber identifier of said recipient on the basis of said string.
